(19) United States
(12) Patent Application Publication
(10) Pub. No.: US 2025/0077167 A1
(43) Pub. Date: Mar. 6, 2025

(54) OPERATION DEVICE AND ACOUSTIC DEVICE

(71) Applicant: AlphaTheta Corporation, Yokohama-shi, Kanagawa (JP)

(72) Inventors: Koichi Okamoto, Yokohama-shi, Kanagawa (JP); Taisuke Toda, Yokohama-shi, Kanagawa (JP); Hiroyuki Isobe, Yokohama-shi, Kanagawa (JP)

(21) Appl. No.: 18/722,155

(22) PCT Filed: Dec. 24, 2021
(86) PCT No.: PCT/JP2021/048413

§ 371 Date: Jun. 20, 2024

(51) Int. Cl. G06F 3/16; H04R 3/00

(52) U.S. Cl. CPC G06F 3/162; H04R 3/00

(57) ABSTRACT

An operation device includes: a rotary operator (21A, 21B); a determination unit (51) configured to determine whether there is a contact of a user with the rotary operator; and an output unit (52) configured to output, in response to the determination unit determining that there is no contact, first information indicating a playback speed set in advance in the rotary operator and, in response to the determination unit determining that there is the contact, second information different from the first information.

### TECHNICAL FIELD

The present invention relates to an operation device and an acoustic device.

### BACKGROUND ART

A variety of acoustic equipment with a jog wheel has been known. For instance, known DJ equipment is acoustic equipment equipped with a rotary operator called motorized jog wheel, the rotary operator including a base (a platter) to be driven and rotated by a motor and an operation board (VINYL) placed on an upper side of the base similarly to an analog turntable (for instance, Non-patent Literature 1).

In the motorized jog wheel, a user can rotate the operation board by performing a rotating operation on the platter and the VINYL. In such a case, it is also possible to perform scratch playback to play a sound similar to scratching an analog record by changing a playback speed of a music piece in accordance with the rotating operation performed on the platter and the VINYL by the user.

### CITATION LIST

### Non-Patent Literature(s)

Non-patent Literature 1: The manual of Technics DIRECT DRIVE DIGITAL TURNTABLE SL-DZ1200 (https://panasonic.jp/audio/p-db/SL-DZ1200_manualdl.html)

### SUMMARY OF THE INVENTION

### Problem(s) to be Solved by the Invention

Since a motorized jog wheel is driven and rotated by a motor, the rotation speed becomes uneven in some cases. In such a case, if a playback speed of a music piece is changed in accordance with the rotation speed of the motorized jog wheel, the unevenness will also be reflected in the playback speed. As a result, a sound quality becomes poor to also affect a distortion rate that is an item regarding audio performance.

Moreover, a mixing process to simultaneously play a plurality of music pieces is usually performed during a DJ performance. The above-described unevenness of the playback speed makes it difficult to accurately align playback points of a plurality of music pieces to be mixed, also deteriorating the quality of a DJ performance.

The invention is intended to at least partly solve the above-described problem and an object of the invention is to provide an operation device and an acoustic device that enable a favorable playback of a music piece even when a rotation speed becomes uneven.

### Means for Solving the Problem(s)

[1] An operation device including: a rotary operator; a determination unit configured to determine whether there is a contact of a user with the rotary operator; and an output unit configured to output, in response to the determination unit determining that there is not the contact, first information indicating a playback speed set in advance in the rotary operator and, in response to the determination unit determining that there is the contact, second information different from the first information.
[2] The operation device according to [1], further including: a detector configured to detect a rotation speed of the rotary operator, in which the determination unit is configured to determine that there is not the contact when a difference between the playback speed set in advance in the rotary operator and a playback speed based on the rotation speed detected by the detector is less than a predetermined threshold.
[3] The operation device according to [2], in which the determination unit is configured to determine that there is the contact when the difference is equal to or more than the predetermined threshold, and the output unit is configured to output, as the second information, information indicating the playback speed based on the rotation speed detected by the detector in response to the determination unit determining that there is the contact.
[4] The operation device according to [2] or [3], in which the rotary operator includes a first operation member configured to be driven and rotated by a motor and a second operation member relatively rotatable with respect to the first operation member coaxially with the first operation member, the detector includes a first detector configured to detect a rotation speed of the first operation member and a second detector configured to detect a rotation speed of the second operation member, and the determination unit is configured to determine that there is not the contact when both a difference between the playback speed based on the rotation speed of the first operation member detected by the first detector and the playback speed set in advance in the rotary operator and a difference between the playback speed based on the rotation speed of the second operation member detected by the second detector and the playback speed set in advance in the rotary operator are less than the predetermined threshold.
[5] The operation device according to [4], in which the determination unit is configured to: determine that there is the contact when both the difference between the playback speed based on the rotation speed of the first operation member and the playback speed set in advance in the rotary operator and the difference between the playback speed based on the rotation speed of the second operation member and the playback speed set in advance in the rotary operator are equal to or more than the predetermined threshold; and determine whether there is the contact with each of the first operation member and the second operation member on a basis of a difference between the playback speed based on the rotation speed of the first operation member and the playback speed based on the rotation speed of the second operation member.
[6] The operation device according to any one of [1] to [5], further including: a second detector including a sensor configured to detect the contact of the user with the rotary operator, in which the determination unit is configured to determine whether there is the contact on a basis of an output from the sensor.
[7] An acoustic device including: the operation device according to any one of [1] to [6]; and a playback device configured to play music piece data, in which the output unit is configured to output at least one of the first information or the second information to the playback device.

### BRIEF EXPLANATION OF DRAWING(S)

FIG. 1 schematically illustrates a configuration of an acoustic device according to an exemplary embodiment.

FIG. 2 is a plan view illustrating a schematic functional configuration of an operation device according to an exemplary embodiment.

FIG. 3 schematically illustrates a schematic functional configuration related to a jog wheel according to an exemplary embodiment.

FIG. 4A is a diagram of assistance in explaining an output process by an output unit according to an exemplary embodiment.

FIG. 4B is another diagram of assistance in explaining the output process by the output unit according to the exemplary embodiment.

FIG. 5 is a flowchart illustrating a process to be performed by a controller according to an exemplary embodiment.

### DESCRIPTION OF EMBODIMENT(S)

Description will be made below on an exemplary embodiment of the invention with reference to the drawings.

### Schematic Configuration of Acoustic Device

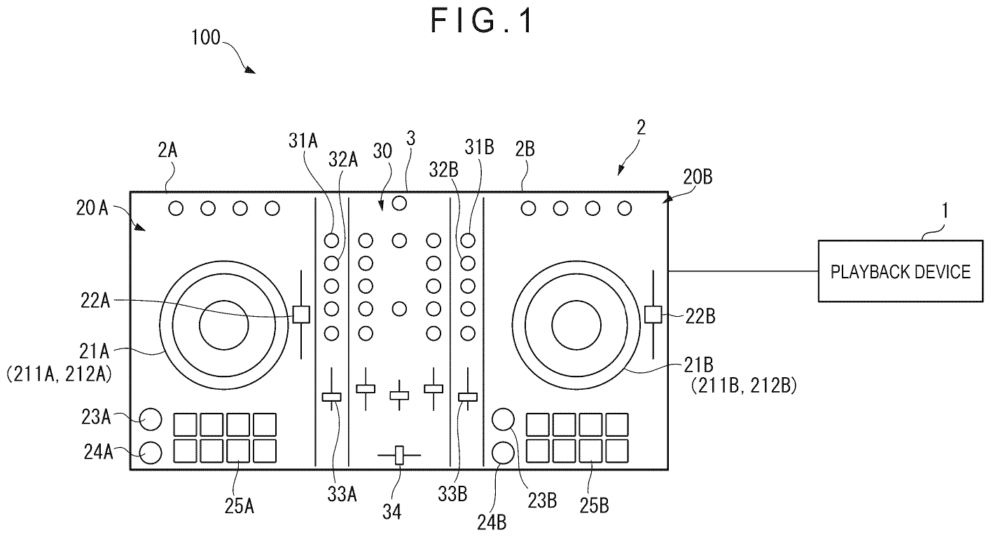

FIG. 1 schematically illustrates a configuration of an acoustic device 100 according to the exemplary embodiment.

As illustrated in FIG. 1, the acoustic device 100 according to the exemplary embodiment includes a playback device 1 and an operation device 2 and performs playback of a music piece in accordance with a user operation relative to the operation device 2.

Description will be made below on components of the acoustic device 100.

### Configuration of Playback Device

The playback device 1 plays a music piece by playing music data selected by a user from among stored music data. In addition to the above, the playback device 1 communicates with the operation device 2 and adds, on the basis of information outputted from the operation device 2, a variety of acoustic effects to the music piece currently being played. The playback device 1 may be configured by an information processing device such as a personal computer (PC).

### Configuration of Operation Device

As illustrated in FIG. 1, the operation device 2 includes operation units 20A and 20B provided in players 2A and 2B, respectively, and an operation unit 30 provided in a mixer 3.

The operation unit 20A receives a user operation for the player 2A. The operation unit 20B receives a user operation for the player 2B. Moreover, the operation unit 30 receives a user operation for the mixer 3.

The operation unit 20A includes a jog wheel 21A, a tempo slider 22A, a cue button 23A, a play/pause button 24A, and a performance pad 25A.

The jog wheel 21A, which functions as a rotary operator, is a circular rotary operator to be used to set a playback direction and a playback speed of a music piece currently being played by the player 2A. The jog wheel 21A includes a turntable platter 211A and a top plate 212A.

Similarly to an analog turntable, the turntable platter 211A is a base portion to be driven and rotated by a non-illustrated motor housed inside the operation device 2.

The top plate 212A is located on a surface of the turntable platter 211A and relatively rotatable with respect to the turntable platter 211A coaxially with the turntable platter 211A.

A user can perform a variety of DJ performances such as scratch and pitch and bend by rotating at least one of the turntable platter 211A or the top plate 212A of the jog wheel 21A forward or reversely or changing a rotation speed.

The tempo slider 22A is a lever that adjusts a playback speed of a music piece currently being played by the player 2A.

The cue button 23A is a button to be pressed to set a predetermined point in a music piece as a cue point.

The play/pause button 24A is a button to be pressed to cause the player 2A to start or stop playing a music piece.

The performance pad 25A is a versatile operator capable of being assigned with various functions relating to the playback control.

The operation unit 20B includes a jog wheel 21B including a turntable platter 211B and a top plate 212B in the same manner as the operation unit 20A. The operation unit 20B includes a tempo slider 22B, a cue button 23B, a play/pause button 24B, and a performance pad 25B in the same manner as the operation unit 20A.

In accordance with a user's operation, the mixer 3 switches playback between a music piece by the player 2A and a music piece by the player 2B, adjusts a sound volume of each of channels, and applies an effect on the music piece being played.

The operation unit 30 of the mixer 3 includes effect selecting knobs 31A and 31B, effect amount adjusting knobs 32A and 32B, channel faders 33A and 33B, and a cross fader 34.

The effect selecting knobs 31A and 31B are knobs to be used for selecting effects to be applied to music pieces currently being played by the player 2A and 2B, respectively.

The effect amount adjusting knobs 32A and 32B are knobs to be used for adjusting parameters, such as depths and magnitudes, of effects to be applied to music pieces currently being played by the players 2A and 2B, respectively.

The channel faders 33A and 33B are levers to be used for adjusting output volume levels of music pieces currently being played by the players 2A and 2B, respectively.

The cross fader 34 is a lever to be used for switching output volume levels of music pieces to be outputted from the players 2A and 2B.

It should be noted that the operation units 20A, 20B and the operation unit 30 optionally further include a touch panel for detecting a contact point by a user and the like components in addition to the above.

### Configuration of Operation Device

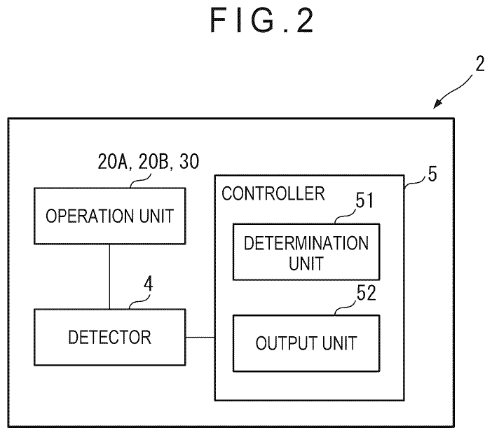

FIG. 2 is a block diagram illustrating a schematic functional configuration of an operation device according to an exemplary embodiment. The operation device 2 includes a detector 4 and a controller 5 as illustrated in FIG. 2.

The detector 4 detects an input operation by a user performed on the operation units 20A, 20B and the operation unit 30 and supplies a detection result to the controller 5.

The controller 5, which is implemented in the operation device 2 in a form of, for instance, a communication interface, a processor (e.g., Central Processing Unit (CPU)), and a memory providing a working area, controls the operation of the operation device 2. The controller 5 includes a determination unit 51 and an output unit 52, which are to be implemented by the processor that works in accordance with a program stored in the memory or received through the communication interface.

The determination unit 51 makes a variety of determinations according to the detection result from the detector 4. Details of the determinations will be described later.

The output unit 52 outputs information based on the detection result of the detector 4 to the playback device 1 according to a determination result of the determination unit 51.

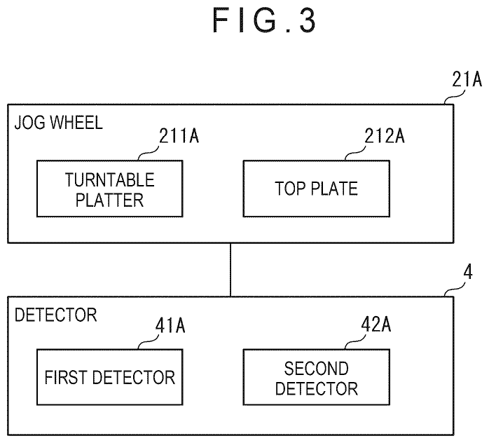

FIG. 3 is a block diagram illustrating a schematic functional configuration related to the jog wheel 21A. As illustrated in FIG. 3, the detector 4 includes a first detector 41A and a second detector 42A corresponding to the turntable platter 211A and the top plate 212A of the jog wheel 21A, respectively.

The first detector 41A detects a rotation speed Sr1 of the turntable platter 211A and the second detector 42A detects a rotation speed Sr2 of the top plate 212A. Likewise, the detector 4 includes, for the player 2B, a first detector 41B that detects a rotation speed Sr1 of the turntable platter 211B and a second detector 42B that detects a rotation speed Sr2 of the top plate 212B.

### Determination Process by Determination Unit

The determination unit 51 makes a variety of determinations according to the detection result from the detector 4 as described above. Description will be made below on a determination process to determine whether there is a contact of a user by taking the jog wheel 21A of the player 2A as an example. For the jog wheel 21B of the player 2B, the determination process to determine whether there is a contact of the user is performed in the same manner.

The determination unit 51 compares a difference between a playback speed set in advance in the rotary operator, i.e., the jog wheel 21A, and a playback speed (Sp1, Sp2) based on a rotation speed (Sr1, Sr2) detected by the detector 4 with a predetermined threshold, thereby determining whether there is a contact of a user with the jog wheel 21A.

Whether there is a contact of the user with the jog wheel 21A may be identified as one of the following four states.

### (1) Not Contacted: STATE 1

During normal playback, the jog wheel 21A is driven and rotated at a rotation speed corresponding to the playback speed set in advance, for instance, a playback speed Sp0 set by the tempo slider 22A. Then, when there is no contact of the user on the jog wheel 21A, the playback speed Sp1 based on the rotation speed Sr1 of the turntable platter 211A becomes substantially equal to the playback speed Sp0 set by the tempo slider 22A. The playback speed Sp2 based on the rotation speed Sr2 of the top plate 212A also becomes substantially equal to the playback speed Sp0 set by the tempo slider 22A.

Accordingly, when a difference between the playback speed Sp0 set by the tempo slider 22A and the playback speed Sp1 based on the rotation speed Sr1 of the turntable platter 211A is less than a predetermined threshold and a difference between the playback speed Sp0 set by the tempo slider 22A and the playback speed Sp2 based on the rotation speed Sr2 of the top plate 212A is less than the predetermined threshold, it is possible to determine that there is no contact of the user on the jog wheel 21A.

### (2) Contacted (the Top Plate 212A Only): STATE 2

When the user contacts the top plate 212A and performs a so-called scratch operation including rotating the top plate 212A forward or reversely and changing the rotation speed, the playback speed Sp1 based on the rotation speed Sr1 of the turntable platter 211A differs from the playback speed Sp2 based on the rotation speed Sr2 of the top plate 212A.

Accordingly, when a difference between the playback speed Sp1 based on the rotation speed Sr1 of the turntable platter 211A and the playback speed Sp2 based on the rotation speed Sr2 of the top plate 212A is equal to or more than a predetermined threshold, it is possible to determine that there is a contact of the user on the top plate 212A of the jog wheel 21A.

### (3) Contacted (the Turntable Platter 211A Only): STATE 3

When the user contacts the turntable platter 211A and performs a so-called pitch-and-bend operation including rotating the turntable platter 211A forward or reversely and changing the rotation speed, the playback speed Sp1 based on the rotation speed Sr1 of the turntable platter 211A differs from the playback speed Sp0 set by the tempo slider 22A. Moreover, the playback speed Sp1 based on the rotation speed Sr1 of the turntable platter 211A becomes substantially equal to the playback speed Sp2 based on the rotation speed Sr2 of the top plate 212A.

Accordingly, when the difference between the playback speed Sp0 set by the tempo slider 22A and the playback speed Sp1 based on the rotation speed Sr1 of the turntable platter 211A is equal to or more than the predetermined threshold and the difference between the playback speed Sp1 based on the rotation speed Sr1 of the turntable platter 211A and the playback speed Sp2 based on the rotation speed Sr2 of the top plate 212A is less than the predetermined threshold, it is possible to determine that the user contacts only the turntable platter 211A of the jog wheel 21A.

### (4) State Transition Due to any Other Reason: STATE 4

The state may transition for any other reason than the above-described (1) to (3). Examples of such a case include a case in which an operation of changing the rotation speed and the playback speed other than operations via the jog wheel 21A and the tempo slider 22A is performed and a case where the playback of a music piece is started or stopped by the play/pause button 24A.

### Output Process by Output Unit

The output unit 52 outputs information based on the detection result of the detector 4 to the playback device 1 according to the determination result of the determination unit 51 as described above. Description will be made below on an output process to the playback device 1 by taking the jog wheel 21A of the player 2A as an example. For the jog wheel 21B of the player 2B, the output process to the playback device 1 is performed in the same manner.

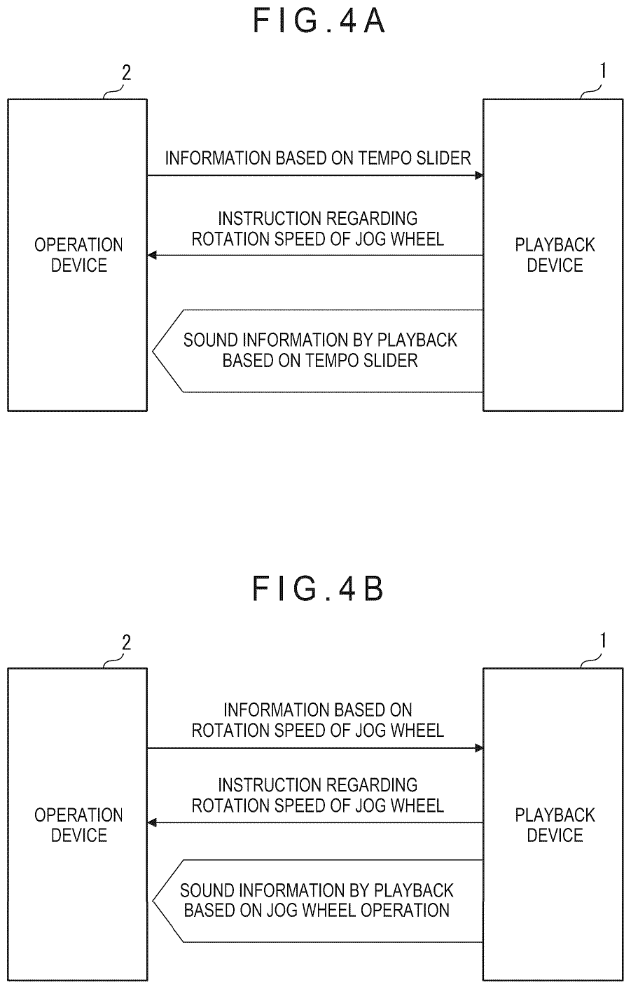

The output unit 52 outputs suitable information to the playback device 1 according to the four states (STATEs 1 to 4) determined by the determination unit 51. FIG. 4A and FIG. 4B are diagrams of assistance in explaining the output process by the output unit 52.

### (1) Not Contacted: STATE 1

In response to the determination unit 51 determining that there is no contact of the user on the jog wheel 21A, the output unit 52 outputs the playback speed Sp0 set by the tempo slider 22A instead of outputting the playback speed Sp1 based on the rotation speed Sr1 of the turntable platter 211A and the playback speed Sp2 based on the rotation speed Sr2 of the top plate 212A. This is a process for preventing the unevenness of the rotation speed caused in the motorized jog wheel, i.e., the jog wheel 21A, from being also reflected in the playback speed Sp1 of the rotation speed Sr1 of the turntable platter 211A and the playback speed Sp2 based on the rotation speed Sr2 of the top plate 212A.

In a motorized jog wheel, a playback process is usually to be performed on the basis of the playback speed Sp1 based on the rotation speed Sr1 of the turntable platter 211A and the playback speed Sp2 based on the rotation speed Sr2 of the top plate 212A.

In contrast, in the exemplary embodiment, in response to the determination unit 51 determining that there is no contact of the user on the jog wheel 21A, the output unit 52 of the operation device 2 outputs information based on the tempo slider 22A as illustrated in FIG. 4A. The playback device 1 then performs a playback process in accordance with the information based on the tempo slider 22A. As a result, it is possible to prevent a sound quality of a played music piece from becoming poor due to the unevenness of the rotation speed of the motorized jog wheel, i.e., the jog wheel 21A, and to also prevent an influence on a distortion rate that is an item regarding audio performance.

It should be noted that the information outputted from the output unit 52 may include information indicating that “there is no contact of the user on the jog wheel 21A.”

### (2) Contacted (the Top Plate 212A Only): STATE 2

In response to the determination unit 51 determining that there is a contact of the user on the top plate 212A of the jog wheel 21A, the output unit 52 outputs the playback speed Sp1 based on the rotation speed Sr1 of the turntable platter 211A and the playback speed Sp2 based on the rotation speed Sr2 of the top plate 212A.

That is to say, in response to the determination unit 51 determining that there is a contact of the user on the top plate 212A of the jog wheel 21A, the output unit 52 of the operation device 2 outputs information based on the jog wheel 21A as illustrated in FIG. 4B. The playback device 1 then performs a playback process in accordance with the information based on the tempo slider 21A. As a result, in response to the determination unit 51 determining that there is a contact of the user on the top plate 212A of the jog wheel 21A, it becomes possible to perform a scratch-playback process or the like in accordance with information actually detected in the jog wheel 21A.

It should be noted that the information outputted from the output unit 52 is not necessarily the playback speed and may include a rotation speed, a rotation angle, a rotation direction, and the like. Moreover, information indicating that “there is a contact of the user on the top plate 212A of the jog wheel 21A” may be included.

### (3) Contacted (the Turntable Platter 211A Only): STATE 3

In response to the determination unit 51 determining that there is a contact of the user on the turntable platter 211A of the jog wheel 21A, the output unit 52 outputs at least the playback speed Sp1 based on the rotation speed Sr1 of the turntable platter 211A.

That is to say, in response to the determination unit 51 determining that there is a contact of the user on the turntable platter 211A of the jog wheel 21A, the output unit 52 of the operation device 2 outputs information based on the jog wheel 21A as illustrated in FIG. 4B as in (2) described above. The playback device 1 then performs a playback process in accordance with the information based on the tempo slider 21A. As a result, in response to the determination unit 51 determining that there is a contact of the user on the turntable platter 211A of the jog wheel 21A, it becomes possible to perform a pitch-and-bend playback process or the like in accordance with information actually detected in the jog wheel 21A.

It should be noted that in response to the determination unit 51 determining that there is a contact of the user on the turntable platter 211A of the jog wheel 21A, the output unit 52 may output the playback speed Sp2 based on the rotation speed Sr2 of the top plate 212A in addition to the playback speed Sp1 based on the rotation speed Sr1 of the turntable platter 211A. Moreover, the information outputted from the output unit 52 is not necessarily the playback speed and may include a rotation speed, a rotation angle, a rotation direction, and the like. Moreover, information indicating that “there is a contact of the user on the top plate 212A of the jog wheel 21A” may be included.

### (4) State Transition Due to any Other Reason: STATE 4

In response to the determination unit 51 determining that state transition occurs for any other reason than (1) to (3), the output unit 52 outputs information corresponding to the state transition. For instance, when an operation of starting or stopping the playback of a music piece is performed with the play/pause button 24A, the output unit 52 outputs information indicating this operation.

### Output Process of Information Based on Determination Process

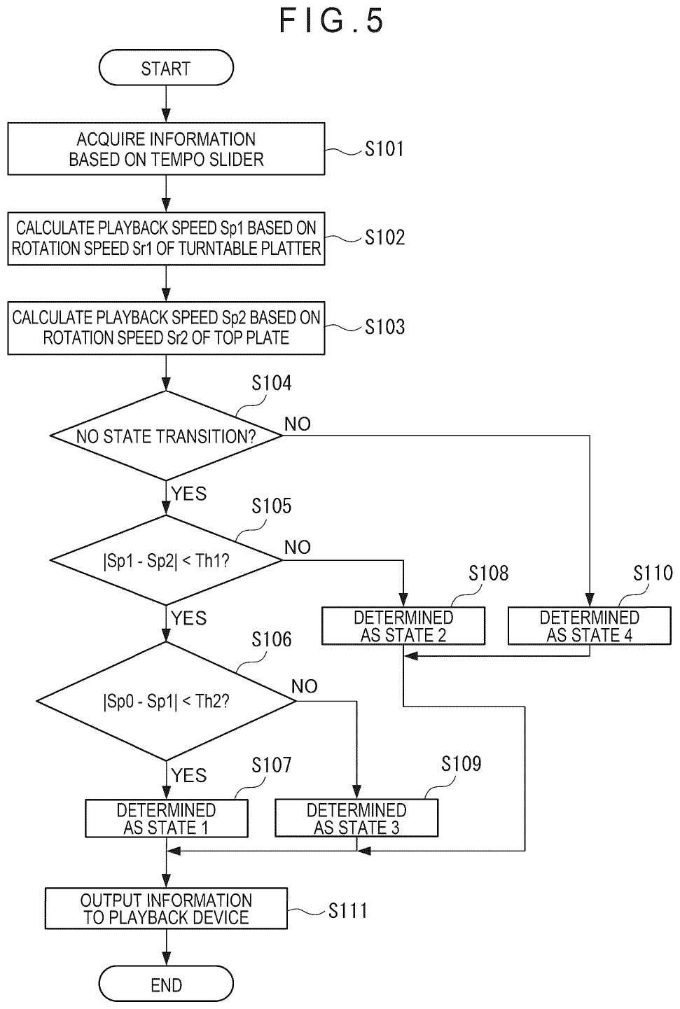

FIG. 5 is a flowchart illustrating a process to be performed by the controller 5. Description will be made below by taking the jog wheel 21A of the player 2A as an example. The same process also applies to the jog wheel 21B of the player 2B.

The determination unit 51 acquires information based on the tempo slider 22A from the detector 4 (Step S101).

Next, the determination unit 51 acquires information indicating the rotation speed Sr1 of the turntable platter 211A from the first detector 41A of the detector 4 and calculates the playback speed Sp1 based on the rotation speed Sr1 (Step S102). The determination unit 51 also acquires information indicating the rotation speed Sr2 of the top plate 212A from the second detector 42A of the detector 4 and calculates the playback speed Sp2 based on the rotation speed Sr2 (Step S103).

Subsequently, the determination unit 51 determines whether another state transition different from the operations on the jog wheel 21A and the tempo slider 22A occurs (Step S104).

In response to the state transition being determined to occur through the determination process in Step S104 (Step S104: NO), the process of the controller 5 proceeds to later-described Step S110.

In response to the determination unit 51 determining that no state transition occurs through the determination process in Step S104 (Step S104: YES), the determination unit 51 determines whether a difference between the playback speed Sp1 based on the rotation speed Sr1 of the turntable platter 211A and the playback speed Sp2 based on the rotation speed Sr2 of the top plate 212A is less than a predetermined threshold Th1 (Step S105).

When the difference is determined to be equal to or more than the predetermined threshold Th1 through the determination process in Step S105 (Step S105: NO), the process of the controller 5 proceeds to later-described Step S108.

When the difference is determined to be less than the predetermined threshold Th1 through the determination process in Step S105 (Step S105: YES), the determination unit 51 determines whether a difference between the playback speed Sp0 set by the tempo slider 22A and the playback speed Sp1 based on the rotation speed Sr1 of the turntable platter 211A is less than a predetermined threshold Th2 (Step S106)

When the difference between the playback speed Sp0 set by the tempo slider 22A and the playback speed Sp1 based on the rotation speed Sr1 of the turntable platter 211A is determined to be equal to or more than the predetermined threshold Th2 through the determination process in Step S106 (Step S106: NO), the process of the controller 5 proceeds to later-described Step S109.

When the difference between the playback speed Sp0 set by the tempo slider 22A and the playback speed Sp1 based on the rotation speed Sr1 of the turntable platter 211A is determined to be less than the predetermined threshold Th2 through the determination process in Step S106 (Step S106: YES), the determination unit 51 determines that a state of whether there is a contact of the user with the jog wheel 21A is STATE 1 (Step S107), since the playback speed Sp0 set by the tempo slider 22A, the playback speed Sp1 based on the rotation speed Sr1 of the turntable platter 211A, and the playback speed Sp2 based on the rotation speed Sr2 of the top plate 212A are substantially equal.

When the difference is determined to be equal to or more than the predetermined threshold Th1 through the determination process in Step S105 (Step S105: NO), the determination unit 51 determines that the state of whether there is a contact of the user with the jog wheel 21A is STATE 2 (Step S108), since the playback speed Sp1 based on the rotation speed Sr1 of the turntable platter 211A differs from the playback speed Sp2 based on the rotation speed Sr2 of the top plate 212A.

Moreover, when the difference between the playback speed Sp0 set by the tempo slider 22A and the playback speed Sp1 based on the rotation speed Sr1 of the turntable platter 211A is determined to be equal to or more than the predetermined threshold Th2 through the determination process in Step S106 (Step S106: NO), the determination unit 51 determines that the state of whether there is a contact of the user with the jog wheel 21A is STATE 3 (Step S109), since the playback speed Sp0 set by the tempo slider 22A differs from the playback speed Sp1 based on the rotation speed Sr1 of the turntable platter 211A and the playback speed Sp1 based on the rotation speed Sr1 of the turntable platter 211A and the playback speed Sp2 based on the rotation speed Sr2 of the top plate 212A are substantially equal.

Further, in response to occurrence of the state transition being determined to have occurred through the determination process in Step S104 (Step S104: NO), the controller 5 determines that the state of whether there is a contact of the user with the jog wheel 21A is STATE 4 (Step S110).

The output unit 52 outputs information to the playback device 1 in accordance with the state of whether there is a contact of the user with the jog wheel 21A, which is determined in one of Steps S107 to S110 (Step S111).

The series of steps are repeatedly performed until a predetermined termination operation is performed, for instance, the operation device 2 is turned off.

### Effects of Embodiment

The operation device 2 according to the exemplary embodiment described hereinabove makes it possible to produce the following effects.

The operation device 2 includes the rotary operators, i.e., the jog wheels 21A, 21B, the determination unit 51 that determines whether there is a contact of a user with the jog wheels 21A, 21B, and the output unit 52 that outputs, in response to the determination unit 51 determining that there is no contact, first information indicating a playback speed set in advance in the jog wheels 21A, 21B and outputs, in response to the determination unit 51 determining that there is a contact, second information different from the first information.

Such a configuration makes it possible to output information for a favorable playback of a music piece even when the rotation speeds of the motorized jog wheels, i.e., the jog wheels 21A, 21B, become uneven. Consequently, it is possible to prevent the sound quality from becoming poor and also affecting a distortion rate, which is an item regarding audio performance, and it is also possible to prevent a reduction in the quality of a DJ performance due to a difficulty in accurate alignment of playback points between a plurality of music pieces to be mixed in a mixing process.

Moreover, the operation device 2 according to the exemplary embodiment further includes the detector 4 that detects the rotation speeds of the jog wheels 21A, 21B. When a difference between the playback speed set in advance in the jog wheels 21A, 21B and the playback speed based on the rotation speed detected by the detector 4 is less than the predetermined threshold, the determination unit 51 determines that there is no contact. In contrast, when the difference is equal to or more than the predetermined threshold, the determination unit 51 determines that there is a contact. In response to the determination unit 51 determining that there is a contact, the output unit 52 outputs, as the second information, information indicating the playback speed based on the rotation speed detected by the detector 4. Consequently, it is possible to determine whether there is a contact of the user with the jog wheels 21A, 21B without the necessity of installation of a dedicated sensor for detecting whether there is a contact of the user. It is also possible to output information for a favorable playback of a music piece depending on whether there is a contact of the user with the jog wheels 21A, 21B.

Moreover, the jog wheels 21A, 21B of the operation device 2 according to the exemplary embodiment include first operation members, i.e., the turntable platters 211A, 211B, to be driven and rotated by a motor, and second operation members, i.e., the top plates 212A, 212B, relatively rotatable with respect to the turntable platters 211A, 211B coaxially with the turntable platters 211A, 211B, respectively. The detector 4 includes the first detectors 41A, 41B that detect the rotation speeds of the turntable platters 211A, 211B and the second detectors 42A, 42B that detect the rotation speeds of the top plates 212A, 212B, respectively. Then, when respective differences of the playback speeds (Sp1, Sp2) based on the rotation speeds (Sr1, Sr2) of the turntable platters 211A, 211B detected by the first detectors 41A, 41B and the top plates 212A, 212B from the playback speed Sp0 set in advance in the jog wheels 21A, 21B both are less than the predetermined threshold, the determination unit 51 determines that there is no contact. In contrast, when respective differences of the playback speed Sp0 set in advance in the jog wheels 21A, 21B from both of the playback speed Sp1 based on the rotation speed Sr1 of the turntable platters 211A, 211B and the playback speed Sp2 based on the rotation speed Sr2 of the top plates 212A, 212B are equal to or more than the predetermined threshold, the determination unit 51 determines that there is a contact. The determination unit 51 also determines whether there is a contact with each of the turntable platters 211A, 211B and the top plates 212A, 212B on the basis of the difference between the playback speed Sp1 based on the rotation speed Sr1 of the turntable platters 211A, 211B and the playback speed Sp2 based on the rotation speed Sr2 of the top plates 212A, 212B.

This makes it possible to independently determine whether there is a contact on each of the turntable platters 211A, 211B and the top plates 212A, 212B. It is also possible to output information for a favorable playback of a music piece depending on whether there is a contact with each of the turntable platters 211A, 211B and the top plates 212A, 212B.

Moreover, the acoustic device 100 according to the exemplary embodiment includes the above-described operation device 2 and the playback device 1 that plays music piece data, and the output unit 52 outputs at least one of the first information or the second information to the playback device 1. This enables the playback device 1 to achieve a favorable playback of a music piece in accordance with the information outputted from the operation device 2.

### Modification of Embodiments

The scope of the invention is not limited by the above exemplary embodiment but includes any modification and improvement as long as such modification and improvement are compatible with the invention.

In the above exemplary embodiment, the detector 4, by way of example, detects the rotation speeds of the jog wheels 21A, 21B and the determination unit 51 determines whether there is a contact of a user with the jog wheels 21A, 21B on the basis of a detection result from the detector 4 but the invention is not limited to this example.

The detector 4 may include, for instance, a touch sensor that detects whether there is a contact of a user with the jog wheels 21A, 21B and determine whether there is a contact of the user with the jog wheels 21A, 21B on the basis of an output from the touch sensor. It should be noted that the touch sensor may be provided in each of the turntable platters 211A, 211B and the top plates 212A, 212B of the jog wheels 21A, 21B to independently detect the rotation speed of each of those.

Moreover, the touch sensor may be a touch sensor configured to detect pressing. A touch sensor of any sensing type, including capacitive type, capable of detecting a user's operation is usable. Further, whether there is a contact of the user with the jog wheels 21A, 21B may be determined based on a combination of the detection results of the rotation speeds of the jog wheels 21A, 21B described in the exemplary embodiment and a detection result from the touch sensor.

In the above exemplary embodiment, the jog wheels 21A, 21B include, by way of example, the turntable platters 211A, 211B and the top plates 212A, 212B and the top plates 212A, 212B are relatively rotatable with respect to the turntable platters 211A, 211B. The invention is, however, not limited to this example.

Each of the jog wheels 21A, 21B may be an integrally rotatable member including the corresponding one of the turntable platters 211A, 211B and the corresponding one of the top plates 212A, 212B. In such a case, the detector 4 may detect rotation speeds of entireties of the jog wheels 21A, 21B, and the determination unit 51 may determine that there is no contact of the user with the jog wheels 21A, 21B when respective differences of the playback speed set in advance in the jog wheels 21A, 21B from playback speeds based on the rotation speeds of the entireties of the jog wheels 21A, 21B detected by the detector 4 are less than the predetermined threshold and determine that there is a contact of the user with the jog wheels 21A, 21B when the respective differences are equal to or more than the predetermined threshold.

Moreover, the operation device of the invention does not necessarily output information to the playback device 1 that plays music piece data and may output information to other devices and equipment.

Further, the invention is also applicable to, for instance, a DJ system in which a plurality of players that play a music piece and a mixer that controls the players are integrated to form a unitary system.

Moreover, although the 2-channel operation device including the two players 2A and 2B is described in the above exemplary embodiments, for instance, a 4-channel operation device also makes it possible to achieve the same functions.

### EXPLANATION OF CODES

1 . . . playback device, 2 . . . operation device, 2A, 2B . . . player, 3 . . . mixer, 4 . . . detector, 5 . . . controller, 20A, 20B, 30 . . . operation unit, 21A, 21B . . . jog wheel, 22A, 22B . . . tempo slider, 23A, 23B . . . cue button, 24A, 24B . . . play/pause button, 25A, 25B . . . performance pad, 26A, 26B . . . reset button, 27A, 27B . . . time setting button, 31A, 31B . . . effect selecting knob, 32A, 32B . . . effect amount adjusting knob, 33A, 33B . . . channel fader, 34 . . . cross fader, 41A, 41B . . . first detector, 42A, 42B . . . second detector, 51 . . . determination unit, 52 . . . output unit, 211A, 211B . . . turntable platter, 212A, 212B . . . top plate

1. An operation device comprising:
a rotary operator;
a determination unit configured to determine whether there is a contact of a user with the rotary operator; and
an output unit configured to output, in response to the determination unit determining that there is not the contact, first information indicating a playback speed set in advance in the rotary operator and, in response to the determination unit determining that there is the contact, second information different from the first information.

2. The operation device according to claim 1, further comprising a detector configured to detect a rotation speed of the rotary operator, wherein
the determination unit is configured to determine that there is not the contact when a difference between the playback speed set in advance in the rotary operator and a playback speed based on the rotation speed detected by the detector is less than a predetermined threshold.

3. The operation device according to claim 2, wherein
the determination unit is configured to determine that there is the contact when the difference is equal to or more than the predetermined threshold, and
the output unit is configured to output, as the second information, information indicating the playback speed based on the rotation speed detected by the detector in response to the determination unit determining that there is the contact.

4. The operation device according to claim 2, wherein
the rotary operator comprises a first operation member configured to be driven and rotated by a motor and a second operation member relatively rotatable with respect to the first operation member coaxially with the first operation member,
the detector comprises a first detector configured to detect a rotation speed of the first operation member and a second detector configured to detect a rotation speed of the second operation member, and
the determination unit is configured to determine that there is not the contact when both a difference between the playback speed based on the rotation speed of the first operation member detected by the first detector and the playback speed set in advance in the rotary operator and a difference between the playback speed based on the rotation speed of the second operation member detected by the second detector and the playback speed set in advance in the rotary operator are less than the predetermined threshold.

5. The operation device according to claim 4, wherein
the determination unit is configured to:
determine that there is the contact when both the difference between the playback speed based on the rotation speed of the first operation member and the playback speed set in advance in the rotary operator and the difference between the playback speed based on the rotation speed of the second operation member and the playback speed set in advance in the rotary operator are equal to or more than the predetermined threshold; and
determine whether there is the contact with each of the first operation member and the second operation member on a basis of a difference between the playback speed based on the rotation speed of the first operation member and the playback speed based on the rotation speed of the second operation member.

6. The operation device according to claim 1, further comprising: a second detector comprising a sensor configured to detect the contact of the user with the rotary operator, wherein
the determination unit is configured to determine whether there is the contact on a basis of an output from the sensor.

7. An acoustic device comprising:
the operation device according to claim 1; and
a playback device configured to play music piece data, wherein
the output unit is configured to output at least one of the first information or the second information to the playback device.
